(19) United States
(12) Patent Application Publication
(10) Pub. No.: US 2011/0283901 A1
(43) Pub. Date: Nov. 24, 2011

(54) METHOD FOR REGULATING THE TEMPERATURE OF A HOT ISOSTATIC PRESS AND A HOT ISOSTATIC PRESS

(75) Inventor: Matthias Graf, Bretten (DE)

(73) Assignee: DIEFFENBACHER GMBH + CO. KG, Eppingen (DE)

(21) Appl. No.: 13/130,553

(22) PCT Filed: Nov. 23, 2009
(86) PCT No.: PCT/EP2009/008331

§ 371 Date: Aug. 8, 2011

(30) Foreign Application Priority Data
Nov. 23, 2008 (DE) 10 2008 058 329.4

(51) Int. Cl. B30B 9/30; C21D 9/00; B30B 11/00

(52) U.S. Cl. 100/102; 148/559

(57) ABSTRACT

The invention relates to a method for regulating the temperature of a hot isostatic press and to a hot isostatic press, comprising a pressure container (1) having an interior horizontal loading space (19) and insulation (8) arranged in between, wherein heating elements (4) and a loading space (19) having a load (18) are arranged inside the insulation (8), wherein at least one rotational flow (23) is developed actively or passively inside the pressure container (1), in addition to at least one existing natural or activated convection flow for heating or cooling or for maintaining a temperature level. An independent hot isostatic press or one suitable for said method is characterized in that active and/or passive means for developing a rotational flow (23), occurring substantially at an angle to the convection flow, are arranged in the pressure container (1).

The invention relates to a method for tempering a hot isostatic press according to the preamble of claim 1 and a hot isostatic press according to the preamble of claim 10.

Hot isostatic presses (HIP) or autoclave ovens are currently used in many application areas. In them, solid workpieces or molding compounds consisting of powder are compressed in a die under high pressure and high temperature. In this way, materials of the same type, but also or different types, can be bonded together. Generally, the workpieces are placed in an oven with a heater, the oven in turn being surrounded by a high pressure vessel. During or after heating, a complete isostatic compression is performed by pressure on all sides from a fluid and/or inert gas, usually argon, until the workpieces are optimally compressed. This method is also used to carry out a secondary compression of components, for example of ceramic materials, e.g. for hip joint prostheses, for aluminum cast components in automobile or engine construction, as cylinder heads for passenger car engines, or precision cast parts of titanium alloys, e.g. turbine blades. During the secondary compression under high pressure and high temperature, pores that developed in the preceding manufacturing process are closed, existing gaps are closed and microstructure characteristics are improved. Another application area is manufacturing components of powdered materials with contours close to the final contour, which are compressed and sintered during the process.

Generally HIP cycles take a very long time, from several hours to several days. A considerable portion of the cycle costs are caused by the machine hourly rate because of the capital that is invested in them. Especially the relatively long cooling times from operating temperature to a permissible temperature at which the pressure system can be opened without danger, generally take up more than one-third of the cycle time and are not of benefit in process technology. It is now known that the cooling also plays a significant role for the material properties of the parts to be produced. Many materials require compliance with a specific maximum cooling speed for reasons of material quality. In addition, during cooling, it is necessary to ensure that a workpiece itself is cooled uniformly over its volume and not non-uniformly with different temperature zones. During the manufacturing of large components, the inherent stresses in the case of temperature differences can lead to distortion, to cracks with corresponding notch effect or to complete destruction. However such problems can arise even with small parts that are generally placed in the oven in a frame or rack.

Autoclaves with hot gas recirculation with or without mechanical auxiliary equipment, like fans, are sufficiently known from the state of the art. In the application without mechanical auxiliary equipment, the natural convection and the distribution of forms of pressure in the autoclave due to temperature differences that are present or required (heating or cooling on outer walls) can be used. In this case, cooler fluids drop downward and hotter fluids rise. By the use of guide elements, such fluid flows can be used in a controlled manner in order to produce uniform heating or cooling recirculation in the autoclave. In the state of the art, preferably so-called guide or convection sleeves are used that consist of a pipe that is open at the top and bottom. During the heating, heat sources in the oven provide for the drive and the flow that are put in motion, depending on the arrangement of the heat source. For example, in the load chamber (below the load) heating occurs and an upward flow develops in the center of the load chamber and outside on the walls (cooler temperature) a downward flow develops. In order to prevent unpredictable mixture flows, the convection sleeve mentioned above offers the advantage that in the convection slot (between convection sleeve and outside insulation), a controlled downward flow is generated, which ensures that fluids that are cooled again do not enter into the heating chamber for heating before they enter the load chamber again. Also in the cooling process, the cooling fluid drops downward between the convection sleeve and the cooling outer wall/insulation, where it enters the load chamber as colder fluid and thus pushes the warmer fluid on the inside of the convection sleeve upward past the load. At the cover of the HIP system, the flow coming from below pushes the fluid in the direction of the outer areas and thus the fluid falls down again between the outer wall and the convection sleeve. In this process, a corresponding cooling occurs again, whereby the continuous cooling process is maintained. An at least similar process has become known with WO2003/070 402 A1 and a method presented therein for cooling of a hot isostatic press. In this case, during the process hot fluid is drained from the load chamber, mixed with a cool, falling fluid outside the load chamber and the mixed fluid is supplied again to the load chamber. The process itself is complex as regards the conditions that are its goal and thus also requires a complex structure of an associated hot isostatic press with the arrangement of many line areas. It is also disadvantageous that the mixed fluid that is reintroduced flows in an uncontrolled manner into the load chamber and there, under some circumstances, can lead to different cooling speeds if undercuts of the load or the support structure for the load prevent proper flow through the load chamber. In addition, the gas cooled to mixing temperature continues to be supplied from below into the load chamber, which inevitably leads to a temperature gradient between the lower end and the upper end of the load chamber and thus a uniform cooling speed cannot be implemented.

One embodiment for fast cooling of an HIP system has become known, for example, from DE 38 33 337 A1. In this solution, to initiate fast cooling a gas circulation is produced between the hot chamber inside the insulating hood and the cold chamber outside the insulating hood, in that the circuit is opened via valves in the base chamber. In the upper cover of the insulating hood, open holes are continuously present, by which the hot fluid can escape. One disadvantage of the embodiment is that very cold fluid flows back from below into the hot chamber and comes directly in contact with the oven load and/or the workpieces. Thus the hot chamber is filled from the bottom to the top with cold gas. The disadvantage of this is that, for one thing, an abrupt cooling can occur with parameters that cannot be securely controlled and that a uniform cooling speed over the entire batch chamber is not achieved. With large components, due to the non-uniform cooling the problems described above like distortion, cracks or damage can occur. In summary, it is thus known to the person skilled in the art that in the technologically important temperature holding phase, the batch in the load chamber can be held in a very narrow tolerance range of, e.g. ±5° C. In this phase, the known pressure vessel systems tend to have a mixture of hot and cold gas in the load chamber. An attempt is made to compensate this effect by the selective opposite control with the use of active heating elements. In this case, in the pressure vessel systems, the heating elements act on the shroud surfaces of the load chamber and thus can not completely prevent a mixture on the inside of the load chamber. With a design according to WO 2003/070 402 A1, an active convection flow through the load chamber is used in a targeted manner, whereby in any case in holding phases, e.g. between the heating phase and the cooling phases or step-like changes of the temperature, the convection flow comes almost to a stop because of the reduction of the required heating power involved in this and after that the desired effect can no longer be achieved in the holding phase. In other pressure vessel systems with recirculating fans, the flow is oriented purely vertically through the load chamber. In this case, depending on the structure and/or geometry of the load and/or the load frames used, a non-uniform flow can occur in the pressure vessel if zones develop with different flow resistance. Since a fluid flow adapts to the path of least resistance, zones with low flow resistance have better and faster flow through them and are accordingly tempered more quickly. Correspondingly, areas that have no flow or only little flow through them are adjusted less quickly to the new temperature relationships and a non-homogeneous temperature distribution develops in the pressure vessel and/or in the load chamber.

The object of the present invention now consists of producing a method for uniform tempering of a hot isostatic press and of producing a hot isostatic press that is not only suitable for carrying out the method, but also can be operated independently with the advantages of a uniform tempering. Naturally the uniform cooling of the load chamber and/or the load must be considered, whereby a colder fluid is abruptly mixed with hot fluid in the pressure vessel and/or preferably in the load chamber of the hot isostatic press and simultaneously an adequately fast and, above all, secure circulation of the fluid is achieved in the complete pressure vessel, but especially in the load chamber. However, the process can also be used advantageously in the heating and holding phase of the hot isostatic process in order to achieve the best possible temperature uniformity in the load chamber.

Achieving the goal for the method consists, according to claim 1, in that additionally at least one existing natural or activated convection flow can be developed for heating or cooling or for holding a temperature level of at least one rotation flow is developed actively or passively within the pressure vessel.

For the sake of clarity, it should be added that with a natural convection temperature differences in the pressure vessel lead to fluid flows. These can be promoted by heating or cooling elements inside or outside the pressure vessel. In this case, the transition to the activated convection flows are relatively fluid, whereby usually with activated convection flows meaning the shifting of the convection flow, wherein in turn heating or cooling elements, valves, cold bearings, recirculating devices (fans) and/or nozzles can be used. A similar differentiation is made between the active and/or passive development of a rotation flow in the pressure vessel, whereby an active trend of the rotation flow involves auxiliary means that shift or increase the rotation flow by their use, as recirculating devices (fans) and/or nozzles can be used and for passive development of the rotation flow with the use of guide devices, the kinetic energies of the convection flow can be used.

Achieving the object of an independent hot isostatic press or for a hot isostatic press for performing the process, according to claim 10, consists in that active and/or passive means for formation of a rotation flow, which essentially occurs at an angle to the convection flow, are arranged in the pressure vessel.

The isostatic press is suitable for carrying out the process, but can also be operated independently. One teaching of the invention consists in that, in addition to a convection using guiding devices, heating elements, cooling elements, nozzles or recirculating fans, a rotation flow will be forced selectively within the pressure vessel. In addition to a natural convection flow that is activated or already present in the pressure vessel due to temperature differences in the pressure vessel with vertical alignment, a rotation flow at an angle to this forms, which in an optimal manner provides for a mixture of the fluid that is present or admixed, prevents temperature nests and can provide for high heating and/or cooling gradients.

The advantages can be obtained most easily using cooling and/or fast cooling that is preferably performed quickly, whereby the respective advantages, process steps to be run through and/or physical reactions involved during a heating and holding phase to be applied opposite each other can be reproduced and used by the person skilled in the art with no problems.

In an advantageous manner, during the cooling by the rotation flow, the vertical admixture of the cold and hot fluid portions is prevented and simultaneously, the energy transport is brought from the load to, for example, the cooled outside within the pressure vessel. Because of the rotation flow, an increased turbulence occurs in the load chamber and at the same time, a longer overflow length, whereby more time is given to the fluid for absorption or release of the energy to the load and/or the other tempered surfaces, like a cooled exterior. In comparison to the vertical flow, the load chamber has uniform flow through it and no, or significantly fewer, dead areas with unsatisfactory gas and temperature exchange occur. In this case, the rotation flow can be carried out indirectly using passive means, in that the natural or activated convection flow (usually generated by cold nests) is started and obtained by guide devices or the geometric structure inside the pressure vessel, the rising or falling convection flows receive a pulse angled to the convection flow. This can be promoted, for example, by guide plates, fans or selective barriers. Alternatively for extreme planned temperature gradients, injection of fluid, preferably with differentiated temperature value are possible. By using injection at high speed, preferably at the upper end of the load chamber, but also conceivably in the lower area or outside of the load chamber, a cyclone effect develops inside the pressure vessel or the load chamber. This means that cooler fluid is moved by the rotation along the respective walls in the circuit and drops downward due to the higher fluid density. In the outer area of the load chamber, a mixture occurs between the hot fluid from the area of the load and the cold fluid moved in a cyclonic form. The fluid that falls downward in this process thereby pulls hot fluid from the inner area of the load chamber with it, whereby a mixed temperature develops. Because of the optimal mixture and the protection of the load from cold fluid ensured for physical reasons, an optimal and uniform cooling gradient of the individual load parts is ensured. Because of the rotation motion of the fluid and the turbulent flows involved in the inside of the load chamber, it is also ensured that only because of ascending or descending fluid no temperature mixtures in the load chamber can develop because of undercuts in the load or a load carrier. With a purely vertical application of the convection flow, spatial niches with normally-still fluid will be adequately mixed in spite of this in order to perfectly compensate temperature differences because of the rotating fluid and the turbulences that additionally develop therefrom. This ensures that even workpieces with undercuts or complex geometries can be uniformly cooled (heated). In addition, the cooling gradient is greatly increased since no laminar protective flows can form around the workpieces or cooling and/or heating elements forming temperature differences and the rotation flows provide for adequately turbulent upward flows to the workpieces or the cooling and/or heating elements. In addition, the thermodynamic transfer to the workpiece increases significantly during cooling or heating.

In order to be able to efficiently use all of the advantages of the rotation flow, mounting a convection sleeve in the load chamber can be provided for. This is a preferred embodiment of the invention. Because of the spatial division of the load chamber, the formation of an autonomous flow that rotates and at least to some extent with the convection slot is possible. After the exit from the convection slot in the upper or lower area of the load chamber of the pressure vessel, the fluid flows again into the inner load chamber and from there is carried along and mixed by the rotation flow that is present.

In an advantageous manner, this results in an optimal mixture of cooled fluid from the lower area of the load chamber with the fluid from the upper area of the load chamber that is still warm and the new fluid flowing in from the base chamber of the pressure vessel during the cooling phase. In turn, this application must be considered in the opposite manner by heating.

Thus it is assumed that the fluids flowing in convection direction still has a rotation pulse in the convection slot, to the extent they are not driven there by active means or guided by passive means (guide plates). In an advantageous manner, the rotational flows in the convection slot are also significantly increased for an optimal. mixture and compensation of the temperatures and prevents local temperature differences. At the same time, the heat transfer between the walls is significantly increased due to the turbulent upward flow. In addition, the overflow length is clearly extended due to the rotational flow, which especially on tempered surfaces (cooled pressure vessel wall) leads to a significantly better heat transfer and thus more efficient cooling. The sample also applies analogously for the heating process and/or holding phase, the heat power that more efficiently removed from the heat conductors due to the rotary flow. Depending on the embodiment, in the convection slot guide plate or similarly-acting resistances can be arranged, that support the rotation speed of the fluid during the ascent, decelerate it or provide for a better turbulent mixture.

In another preferred exemplary embodiment, in such a pressure vessel, two circulating circuits are set up, an inner in the area of the load chamber and an outer in the area of the wall of the pressure vessel, whereby the areas can be separated by thick-walled elements of by insulations. By using simple geometric means, the flowing fluid relationships and/or the circulating fluid quantities adjust to each other in the circulation loops, for example by adapted formation of the transition openings or by adjusting means like valves. These sizes of these openings can also be readjusted manually during each load.

In summary, an optimal and uniform temperature change thus adjusts on the inside of the load chamber and temperature gradients are prevented by the rotation flow that is generated. At the same time, by adjustment of the fluid quantity to be exchanged from the outer to the inner circulation loop, the speed of cooling can be regulated from very quickly to very slowly and simply adjusted to the respective application.

With the characteristics according to the invention, it is now possible with the use of temperature changes, as well as during the holding phase within the pressure vessel, but preferably during fast cooling, to achieve a uniform temperature distribution over the entire load chamber and/or depending on the structure in the overall pressure vessel. This especially applies to workpieces with undercuts or for workpieces that must be set up in special frames or brackets. In this way, it is possible to produce a hot isostatic press with precise process management and very low temperature tolerances in the load chamber, which meet the requirements of the HIPs of modern, high performance components. Because of the additionally spaced insulation inside the pressure vessel, two convection circuits can be designed, if necessary with two associated rotation circuits. The rotation flow that flows past the outer parts of the pressure vessel provides for an improved temperature takeover from the walls of the pressure vessel inward and by the selectively controllable exchange between the outer convection circuit and the inner convection circuit, there is a possibility of more easily controlling the intensity of the temperature difference.

Other advantageous measures and designs of the object of the invention will be seen from the subclaims and the following description with the drawing.

In the drawings:

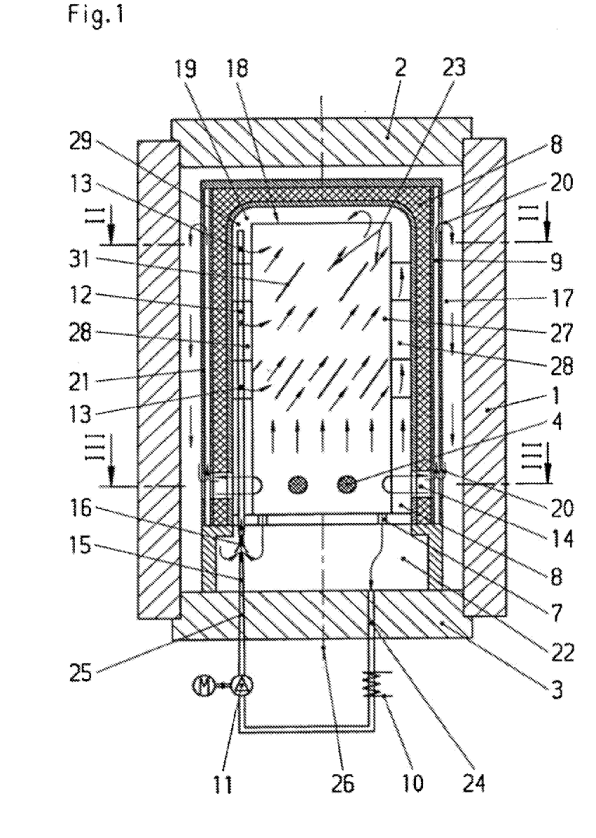

FIG. 1 shows a schematic representation of a vertical cross section through the center axis of a pressure vessel with a top view of a convection sleeve around the load chamber,

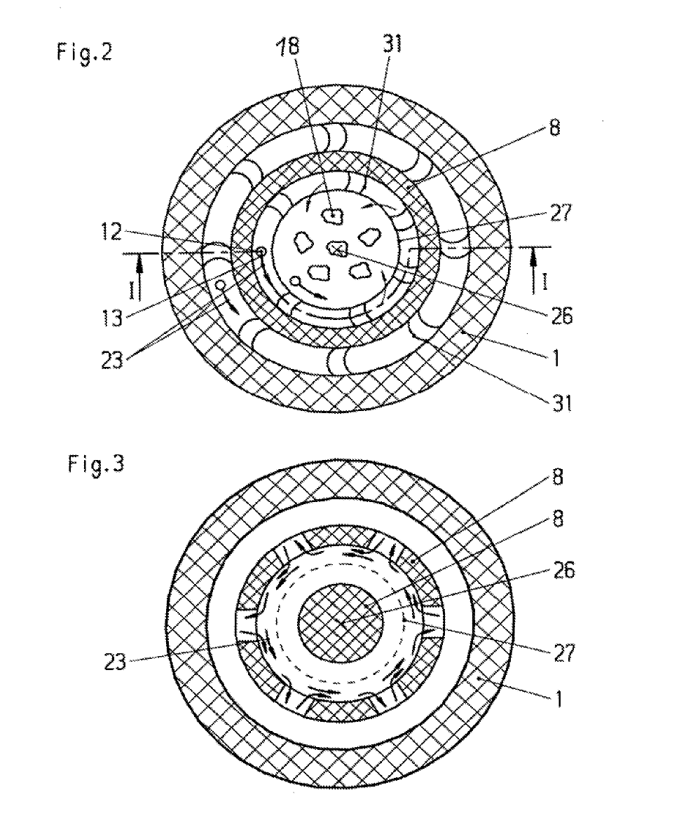

FIG. 2 shows a horizontal cross section through an injection plane in the upper area of the load chamber of the pressure vessel according to FIG. 1 with representation of the cross section line of FIG. 1,

FIG. 3 shows another horizontal cross section through the mixing plane between the areas outside and inside the pressure vessel insulation,

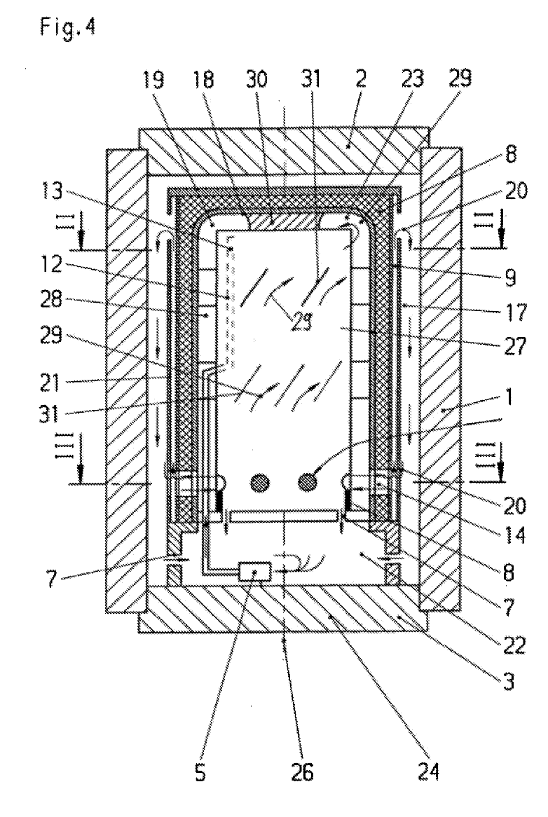

FIG. 4 shows a vertical cross section through the center axis of a pressure vessel with internal tempering by means of a circulating device,

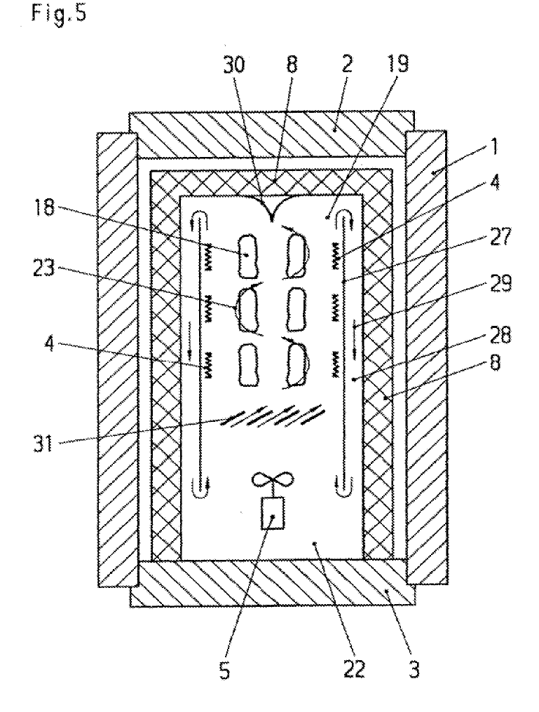

FIG. 5 shows a simplified exemplary embodiment of a pressure vessel with a convection sleeve and circulating device and

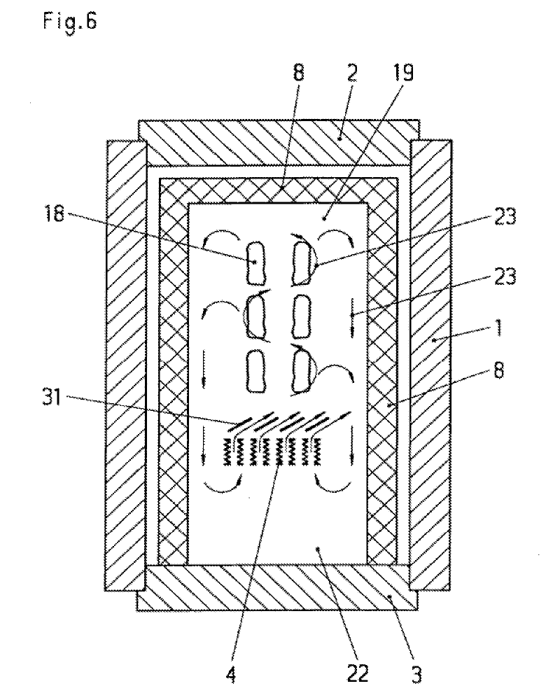

FIG. 6 shows another simplified exemplary embodiment of a pressure vessel with a large load chamber and passive means for forming a rotation flow.

The pressure vessel 1 shown in the figures has a load chamber 19 usually lying on the inside and insulation 8 arranged between the load chamber 19 and the outer walls of the pressure vessel. For formation of a convection slot 28, a convection sleeve 27 is arranged inside the load chamber 19. In the following, a cooling of pressure vessel 1 is explained, as already listed further above. An active heating with heated fluid or by means of heating elements runs analogously for the person skilled in the art, if necessary with modifications relating to the convection direction. In addition, inside the insulation 8, heating elements 4 and a load 18 are found, arranged on a load carrier plate not visible here or piece goods are placed on the load carrier plate by means of a load carrier (not shown).

The pressure vessel 1 also has covers 2 and 3, which can be used for loading and unloading the pressure vessel 1, but will be considered in the following as part of the pressure vessel for simplification of the description. Inside the insulation 8, in the load chamber 19 at least one nozzle 13 is arranged, through which fluid flows for formation of a rotation flow 23, preferably at high speed. In this case, the fluid can have a higher, a lower or the same temperature as the fluid surrounding the nozzle 13. Based on physical laws, cooler fluid is pressed by the rotation flow 23 to the inner wall of the insulation 8 or to the inner wall of the convection sleeve 27. In the present FIG. 1, a rotation flow 23 can be started by means of the nozzles 13, whereby the guide plates 31 are pointed upward for an upward pulse and thus the convection flow 23 in the convection slot 28 is pointed and forced upward. If injection can or will be dispensed with, the fluid in the convection slot 28 would preferentially assume a flow that is pointed downward because of the colder insulation 8, whereby at the same time the guide plates 31 would provide for a rotation flow 23 opposite the one shown in the drawing. In this way, during installation of nozzles 13 and corresponding guide plates 31, the operator has the option of producing a rotation flow 23 in both directions or even to reverse it during a tempering phase (cooling, heating). For example, if during the heating in the convection sleeve 27 with the heating elements 4, the use of the nozzles 13 is dispensed with, the heated fluid would rise on the inside of the convection sleeve. If a prior mixture of the heated fluid is desired for a sensitive load 18, in addition to a simultaneous rotation flow 23, a flow that is directed upward in the convection slot 28 can also be forced by the nozzles, as shown. In this way, in spite of heating by heating elements 4 below the load, the fluid first enters into the convection slot 28, is properly mixed there by the rotation flow and only then goes into the load chamber 19 within the convection sleeve 27. What all these options have in common according to the teaching of the invention is that with active or passive means, a rotation flow 23 can be developed inside the pressure vessel 1, which simultaneously provides for proper mixture of all of the fluid, since it has a pulse direction at an angle to the natural convection flow.

In a cross section perpendicular to the center axis 26 of the pressure vessel 1, fluid of the highest temperature is thus located in the area of the center axis 26, as long as no other special arrangements have been made. Thus the temperature decreases continuously in the direction of insulation 8 during an initialized rotation flow 23. In a preferred embodiment, the fluid flows in horizontally to the center axis 26 of the pressure vessel 1 from at least one nozzle 13. An injection of the fluids that is tangential with respect to the center axis 26 of the pressure vessel 1 is optimal. Naturally, a high speed of the fluid at the outlet of the nozzle 13 and/or the arrangement of several nozzles 13 is advantageous. According to the figures, these can be mounted inside the convection sleeve 27, outside the convection sleeve 27 and/or outside the insulation 8. According to FIG. 4, the fluid either with a differentiated or the same temperature is taken from the base chamber 22 by means of a circulating device 5 and fed directly into the ascending line 12, or as shown in FIG. 1, it can be supplied by way of an outlet 24 outside the pressure vessel 1 to a fluid cooler 10 and then fed by way of an inlet 25 into the line 12. In an especially preferred embodiment, the cooled fluid returned by way of the inlet 25 into the pressure vessel 1 or by an eductor pump consisting of a blast pipe 15 and a venturi nozzle 16, with the admixture of fluid from the base chamber 22 is fed into the line 12 (FIG. 1). In all driving solutions for the rotation flow 23, the fluid can enter from the openings 7 directly from the load chamber 19 and/or from the second ring slot 17 into the base chamber 22. This is a design that is possible to construct and is dependent on cooling speeds, since the fluid from the load chamber 19 is significantly warmer than from the second ring slot 17.

For further optimization of rapid cooling of the entire pressure vessel 1, an outer circulation loop 20 can be established by means of natural convection in two ring slots 9, 17 arranged parallel to each other, whereby the circulation loop 20 is arranged completely outside the insulation 8. The fluid of the outer circulation loop 20 and the rotating fluid from the load chamber 19 can exchange and mix with each other below the load chamber by means of openings 14 in the insulation 8. Hot gas from the rotation flow 23 can hereby go, by way of the openings 14, into the outer circulation loop 20, where it first mixes with the outer circulation flow and is further cooled at the pressure vessel wall 1 by the circulation and can flow, as cooled gas, through the openings 14, back below the load chamber 19.

By the mixture of the cooled fluid supplied externally via the inlet 25 and/or the cooled fluid in the outer ring chamber 17 by way of the wall of the pressure vessel 1, a very intensive and fast cooling of the fluid, and as a consequence, also the load chamber 19 is achieved with a quick cooling according to FIGS. 1 to 4. Naturally a number of variation possibilities are available to the person skilled in the art in the scope of this or other disclosures.

In another preferred embodiment according to FIG. 4, above the load chamber 19, a guide device 30 is mounted. A similar guide device 30 can also be mounted below the load chamber 19. Here the nozzles 13 are arranged inside the convection sleeve 28. This guide device 30 transfers the fluid flows that fluctuate between load chamber 19 and convection slot 28 during the heating or cooling, protectively from or in the edge areas of the load chamber 19. In both application cases, useful advantages result, e.g. during an overflow of cold fluid from the convection slot 28 into the load chamber 19, the cold fluid is prevented from falling without control into the center of the load chamber 19 onto the load 18, since it enters near the edge on the inside of the convection sleeve 27 in the interior of the convection sleeve and is carried along by the rotation flow initiated there or even pressed by an active rotation flow in the load chamber 19 to the inside of the convection sleeve 27. In the reverse case, a suitable formation of the guide device 30 prevents, with regard to flow technology, an unpredictable second flow from rising from the center upward within the convection sleeve 27, cooling there and falling downward or prevents uncontrolled poorly mixed flows in the area of the center line 26 from occurring during the overflow. In the present case, however, this is already prevented by the nozzles 13 arranged inside the convection sleeve 28.

Other preferred exemplary embodiments in connection with the teaching of the invention offer the following possibilities: in order to force an immediate mixture of the cool fluid coming out of the nozzle 13 with hot fluid in the area of the upper insulation 8, it is conceivable to inject the fluid from the nozzle 13 into an eductor nozzle (not shown). In another design variant, additional openings 7 can be provided between the outer ring slot 17 and the base chamber 22, whereby the fluid cooled on the wall of the pressure vessel 1 can flow directly back into the base chamber 22 (FIG. 4).

The system for cooling that is described in great detail and/or the method is naturally analogous for heating or for maintaining a temperature, whereby the heating usually can take place with heating elements only and/or additionally with heated fluid. A selective redistribution of the fluid from warm and/or cold areas of the pressure vessel is conceivable by suctioning and/or pumping in the line 12 to the nozzle 13, in the case of heating as well. In this case, it can be advantageous, for example, to provide two sets of nozzles/lines or switchable lines 12, which alternatively from cool, hot or similarly tempered areas of the pressure vessel 1. FIGS. 5 and 6 show a simplified representation of a pressure vessel 1, which is also functional itself. A design of the pressure vessel such as this and the use of the method therein are conceivable with series production products with few or average demands on the manufacturing process and the uniformity of the tempering, while does not limit the inventive concepts. In the simplified form of the pressure vessel according to FIG. 5, there is a recirculating device 5 in the load chamber 19, which has a convection sleeve 27. During the heating operation, if the heating elements 4 are activated, the fluid rises upward in the convection sleeve 27. At the same time the fluid in the convection slot 28 falls downward due to the cooler outer wall of the insulation 8. A convection flow develops, which can be promoted or decelerated by the circulating device. Due to the guide plates 31, the convection current rising upward experiences a deflection that provides for a rotation flow inside the pressure vessel. The guide device 30 on the upper end of the load chamber 19, which is strictly optional, provides for a better guidance or start of the convection flow. In an advantageous manner, the fluid cooled on the load 18 is transported within the convection sleeve 27 outward in the direction of the heating elements 4, whereby the transfer of heat from the heating elements 4 to cooler fluid is promoted and the formation of a counterflow is prevented, since due to the heating of the fluid the upward kinetic direction is maintained. At the same time, it is provided that warm fluid collects in the area of the load 18 and is mixed to a mixing temperature by the rotation flow 23. The use of a carrier rack (not shown) ensures that the fluids guided from the bottom to the top, which have already released energy at the lower parts of the load 18, have been guided outward and fluids with adequate energy rise further upward and heat the upper parts of the load 18. In an advantageous manner, the carrier frame for the load can have guide plates corresponding to the load or loaded in the manner required in order to temper all parts of the load (18) optimally with the mixture of convection and rotation flow. At the same, for various application cases, different means can be set up for active and/or passive promotion of the rotation flow, whereby the pressure vessel 1 can be adapted optimally to the technology application.

Also without the installation of a convection sleeve 27, with the use of the rotation flow 23, an advantageous convection flow can be achieved in the load chamber 19. For example, if hot gas flows from below by means of active heating elements 4 into the load chamber 19, it rises upward in rotation due to the lift and the intermediate connection of appropriately formed guide plates 31 and releases the heat to the load 18. Due to their higher density, the cooler fluid particles that develop in the course of the heat release, flows outward because the rotation motion and the centrifugal forces, which are higher in comparison to those of the hotter fluid particles, and thus go outside the load chamber 19 to the inner wall of the insulation 8. There the cooler fluid particles collect and because of the higher density, the flow that is pointed upward changes to a flow that is pointed downward, which goes back down into the base chamber 22 below the load chamber 19 and warms there again, as long as it is pressed upward in the direction of the heating elements 4 by even colder fluid. Naturally, circulating devices are also conceivable.

It is understandable to the person skilled in the art that the formation of the active or passive means for creating a rotation flow in the pressure vessel 1 must be left to the application case. In some cases it may make sense for the rotation flow 23 to preferably have its highest speed in the load chamber 19 of a pressure vessel 1.

### REFERENCE NUMBER LIST

1. Pressure vessel

2. Top cover

3. Bottom cover

4. Heating elements

5. Circulation device

7. Openings

8. Insulation

9. Ring slot 1

10. Fluid cooler

11. Compressor

12. Line

13. Nozzle

14. Openings

15. Blast pipe

16. Venturi nozzle

17. Ring slot, outer

18. Load

19. Load chamber

20. Circulation loop, outer

21. Guide plate for 20

22. Base chamber

23. Rotation flow

24. Outlet

25. Inlet

26. Center line

27. Convection sleeve

28. Convection slot

29. Circulation loop, inner

30. Guide device

31. Guide plates

1. Method for tempering a hot isostatic press, consisting of a pressure vessel (1) with load chamber (19) lying inside and insulation (8) arranged between them, whereby heating elements (4) and a load chamber (19) with a load (18) are arranged inside the insulation (8), characterized in that, in addition to at least one existing natural or activated convection flow for heating or cooling or for maintaining a temperature level, at least one rotation flow (23) is developed actively or passively inside the pressure vessel (1).

2. Method according to claim 1, characterized in that the rotation flow (23) is used for increased mixing of the fluid.

3. Method according to claim 1 or 2, characterized in that the rotation flow (23) is used to increase the thermal transfer from the shroud surfaces of the insulation (8) of at least one convection sleeve (27) and/or from the shroud surface of the pressure vessel (1) to the fluid.

4. Method according to one or more of claims 1 to 3, characterized in that the rotation flow (23) is or becomes aligned essentially at an angle to the existing convection flow.

5. Method according to one or more of claims 1 to 4, characterized in that the rotation flow (23) is started and/or driven by active means like circulating devices (5) or nozzles (13).

6. Method according to one or more of claims 1 to 5, characterized in that the rotation flow (23) is driven and/or increased by passive means like guide plates (31) or the like.

7. Method according to one or more of claims 1 to 6, characterized in that the rotation flow (23) is essentially perpendicular to the natural convection flow with a component deviating from the vertical in the direction of the convection flow during the heating or the cooling or during maintaining of a temperature level inside the pressure vessel (1).

8. Method according to one or more of claims 1 to 7, characterized in that preferably the rotation flow (23) has its highest speed in the load chamber (19) of a pressure vessel (1).

9. Method according to one or more of claims 1 to 8, characterized in that a carrier frame for the load (18) has corresponding guide plates (31) for the load (18) or is loaded in the manner necessary in order to optimally temper the load (18) with the mixture of convection and rotation flow.

10. Hot isostatic press, consisting of a pressure vessel (1) with a load chamber (19) lying inside and insulation (8) arranged between them, whereby heating elements (4) and a load chamber (19) with a load (18) is arranged inside the insulation (8) and that active and/or passive means for forming a rotation flow (23), which occurs essentially at an angle to the convection flow, are arranged in pressure vessel (1).

11. Hot isostatic press according to claim 10, characterized in that recirculating devices (5) and/or nozzles (13) are installed as active means.

12. Hot isostatic press according to claim 10 and/or 11, characterized in that guide plates (31) or the like are arranged as passive means.

13. Hot isostatic press according to one or more of claims 10 to 12, characterized in that, in the load chamber (19), a carrier frame is arranged for the load (18), which has active and/or passive means for forming a rotation flow.
